(19) United States
(12) Patent Application Publication
(10) Pub. No.: US 2008/0084036 A1
(43) Pub. Date: Apr. 10, 2008

(54) TOOL AND SUPPLY CART

(76) Inventor: KEVIN V. KEELER, STAR, ID (US)

Correspondence Address: PEDERSEN & COMPANY, PLLC, P.O. BOX 2666, BOISE, ID, 83701, US

(21) Appl. No.: 11/857,278

(22) Filed: Sep. 18, 2007

Related U.S. Application Data
(60) Provisional application No. 60/845,567, filed on Sep. 18, 2006.

(51) Int. Cl. B62B 1/12

(52) U.S. Cl. 280/35

(57) ABSTRACT

A cart has multiple trays, hangers, or other tool or item-receiving levels generally stacked vertically on a wheeled frame. Trays may be shaped with extensions, protruding corner areas, or other shapes adapted to the size or shape of particular tools or objects. Tray rim walls edges may include notches through which portions of tools extend, overhanging beyond the tray perimeter, but from which notches the tools may be easily lifted. Hangers may include blocks or arms, for example, with apertures or holes that receive tools/items so that the tool/items hang from the cart preferably with cutting or nipping heads in closed configuration for safety. Trays or hangers may be fixed in non-horizontal, tilted orientations or may be tiltable and lockable. Such adaptations help the user to know where each tool/item is, so that he/she may grasp it without “digging” through the tools/items, and also increase safety by maintaining sharp or pointed objects in predictable and consistent orientation and/or in closed configuration. Magnets may be provided for capturing metallic items, and removable add-on trays, side-trays, brackets, or other retaining apparatus may be included.

This application claims priority of Provisional Application Ser. No. 60/845,567, filed Sep. 18, 2006, the entire disclosure of which is incorporated herein by this reference.

### BACKGROUND OF THE INVENTION

Field of the Invention

The invention relates generally to a cart for tools, supplies, craft items, or other work, recreation, or hobby items. A preferred embodiment is adapted for use as a farrier's or horseowner's cart.

### SUMMARY OF THE INVENTION

The invention is a cart for carrying and/or storing tools, supplies, craft items, cooking items, or other items for use in work, recreation, housework, hobbies or other activities Preferred embodiments are adapted to carry farrier's tools and supplies. The cart is preferably substantially made of polymer(s) or “plastic(s),” so that contact or impact of metal tools or metal supplies or containers does not make loud or irritating noise, and, especially, does not make noise that would frighten a horse being cared for. The preferred cart comprises a frame on wheels or castors, and a plurality of trays and/or hanger devices, wherein at least one of said trays or hanger devices is selected from the group consisting of: a tray or hanger device that has one or more apertures through which tools or items extend to hang on the cart; and a tray or hanger device that has one or more notches through a side wall through which tools or items extend beyond the perimeter of the tray or hanger; a tray or hanging device that is tilted to a non-horizontal position; and a tray or hanging device that is tiltable to various angles relative to the ground or floor. Preferably, the cart rolls and reaches to a height that is ergonomically adapted for easy grasping and pulling or pushing by a standing user. One or more of the trays or hanging devices may be removable from the frame of the cart.

### BRIEF DESCRIPTION OF THE DRAWINGS

FIG. 1 is a front perspective view of one embodiment of the invented cart.

FIG. 2 is an exploded perspective view of the cart of FIG. 1.

FIG. 3 is a front view of the cart of FIGS. 1 and 2.

FIG. 4 is a right side view of the cart of FIGS. 1-3.

FIG. 5 is a top view of the cart of FIGS. 1-4.

FIG. 6 is a cross-sectional view of the cart of FIGS. 1-5, viewed along the line 6-6 in FIG. 5.

FIG. 7 is a front perspective view of the frame of the cart of FIGS. 1-6.

FIG. 8 is a front view of the frame of FIG. 7.

FIG. 9 is a top view of the frame of FIGS. 7 and 8.

FIG. 10 is a bottom view of the frame of FIGS. 7-9.

FIG. 11 is a right side view of the frame of FIGS. 7-10.

FIG. 12 is a cross-sectional view of the frame of FIGS. 7-11, viewed along the line 12-12 in FIG. 8.

FIG. 13 is a top perspective view of the lower tray of the cart of FIGS. 1-6.

FIG. 14 is a top view of the lower tray of FIG. 13.

FIG. 15 is a top perspective view of the upper tray of the cart of FIGS. 1-6.

FIG. 16 is a top view of the upper tray of FIG. 15.

FIG. 17 is a top perspective view of the hanger of the cart of FIG. 1-6

FIG. 18 is a bottom perspective view of the hanger of FIG. 17.

FIG. 19 is a top view of the hanger of FIGS. 17 and 18.

FIG. 20 is a front perspective view of an alternative embodiment of the invented cart.

FIG. 21 is an exploded perspective view of the cart of FIG. 20.

FIG. 22 is a front perspective view of the frame of the cart of FIGS. 20 and 21.

FIG. 23 is a front view of the frame of FIG. 22.

FIG. 24 is a right side view of the frame of FIGS. 22 and 23.

FIG. 25 is a cross-sectional view of the frame of FIGS. 22-24.

FIG. 26 is a front perspective view of the embodiment of FIGS. 1-6, wherein a tray has been inserted into the hole in the arm of the frame, and tools and supplies are provided in the trays and hangers of the cart.

FIG. 27 is a front view of the embodiment of FIG. 1-6 with a post of a hoof care tool inserted through the arm hole of the frame.

FIG. 28 is a front view of the embodiment of FIG. 1-6 with a hoof care platform inserted through the arm hole of the frame.

FIG. 29 is an alternative embodiment of the invented cart.

### DESCRIPTION OF THE PREFERRED EMBODIMENTS

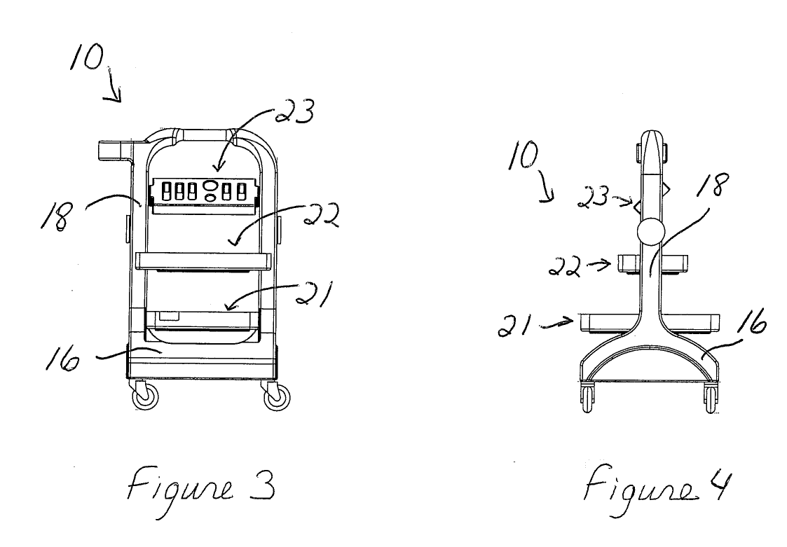

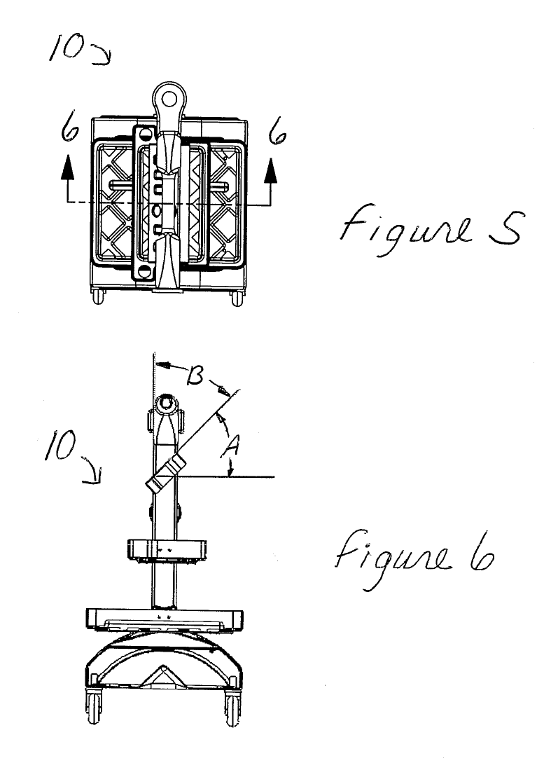

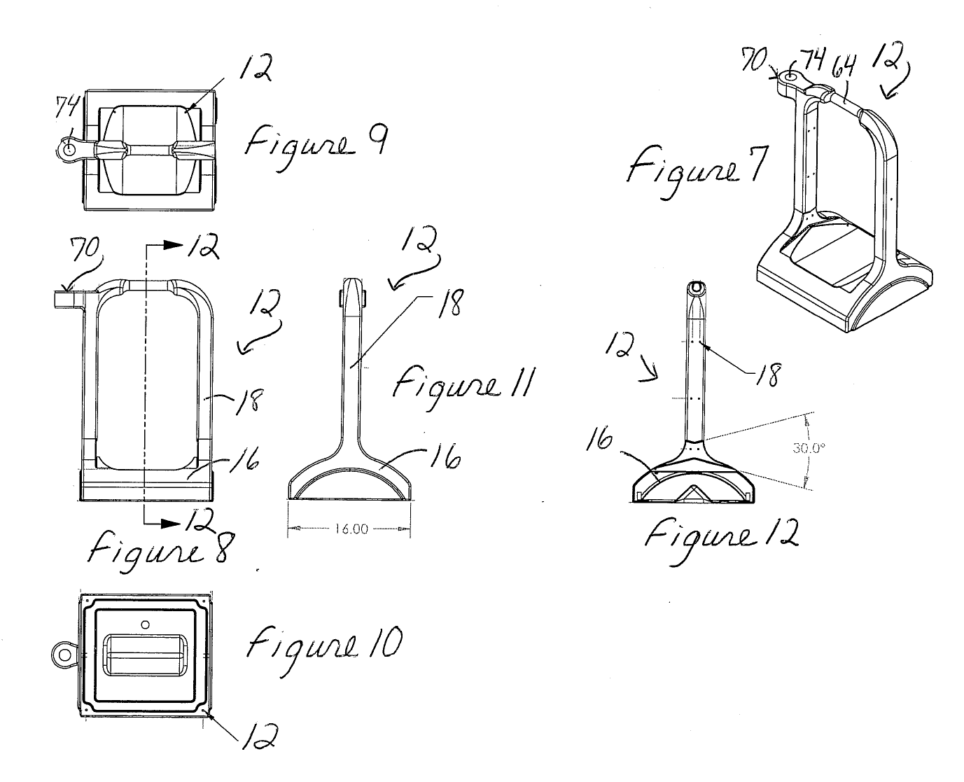

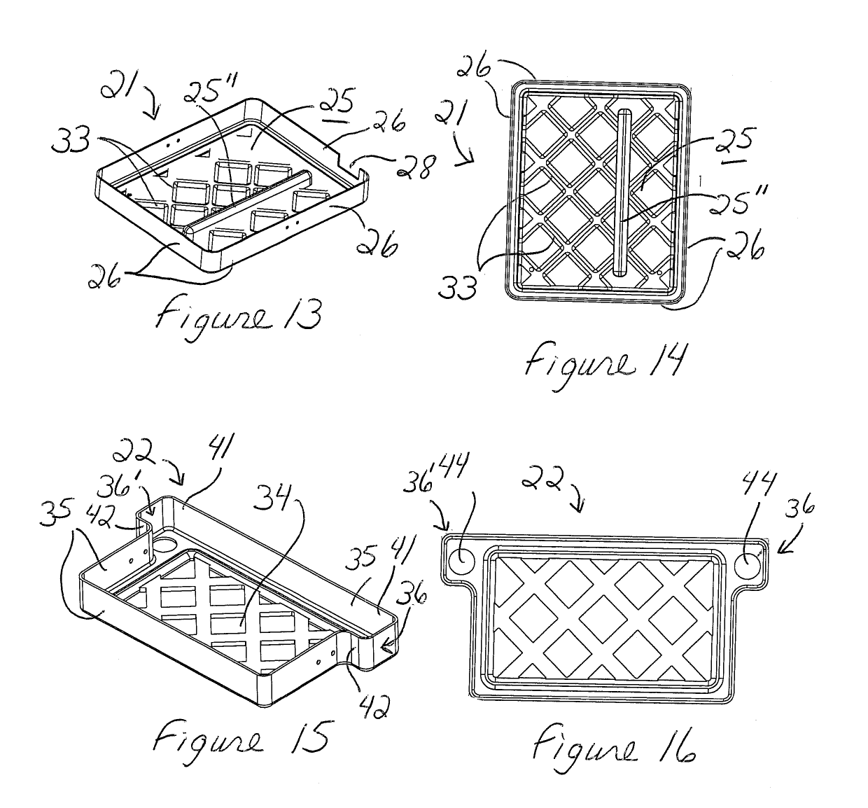

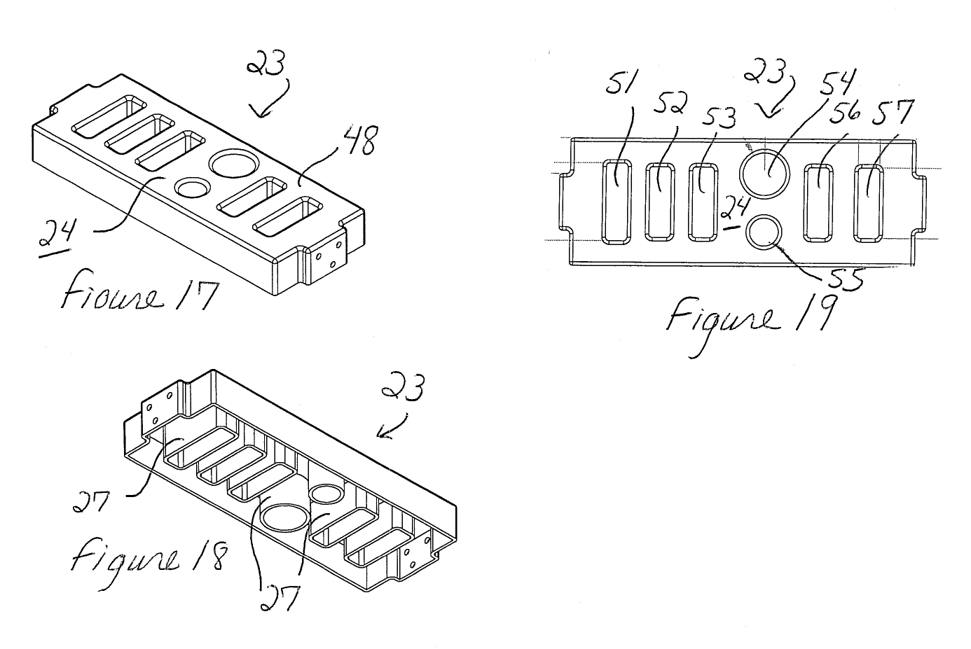

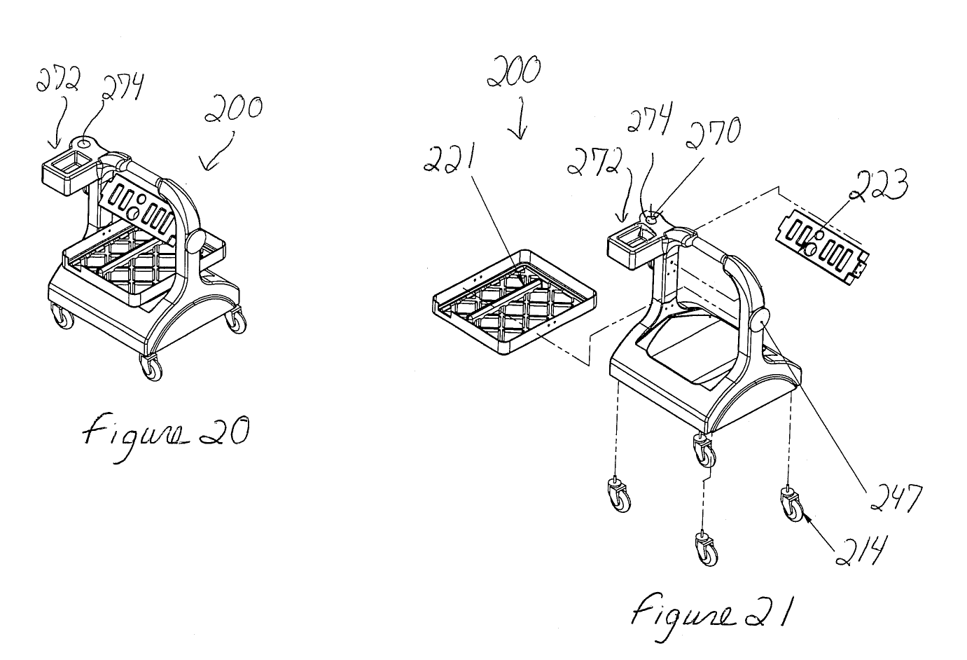

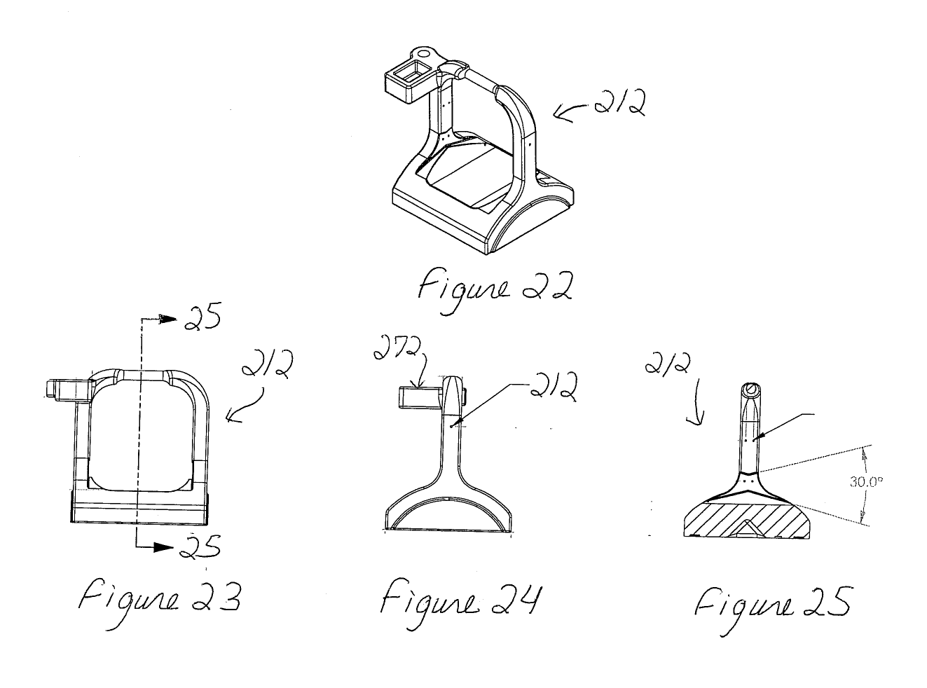

Referring to the Figures, there are shown several, but not the only, embodiments of the invented cart and several, but not the only, embodiments of the invented frames, trays, and hangers for use on a cart frame. The preferred cart 10 comprises a frame 12 on wheels 14 such as commercially-available castors that swivel all directions and may be lockable. The cart frame 12 has a base portion 16 to which the wheels 14 are connected and an upright portion 18 to which multiple trays are attached so that they are received in the interior space 20 of the frame. In the embodiment of FIGS. 1-6, a lower tray 21, a middle tray 22, and an upper hanger 23 are each connected to the frame 12 and lie generally horizontally across the interior space 20. The trays 21, 22 and hanger 23 may be molded integrally with the frame, or may be bolted or otherwise fastened to the frame 12. Preferably, the trays 21, 22 and hanger 23 are rigidly fastened/attached to the frame 12 so that they are immoveable relative to the frame. Alternatively, they may be adjustable relative to the frame, especially adjustable to tilt forward or rearward, and lockable so that they do not pivot relative to the frame 12 during normal use. Most preferably, the two trays 21, 22 are horizontal or within 20 degrees or less from horizontal (with the cart 10 typically resting on a horizontal floor, ground, or other surface), the hanger 23 is tilted about 40-60 degrees from horizontal (angle A being 40-60 degrees and preferably 45 degrees, and angle B being 50-30 degrees and preferably 45 degrees, FIG. 6), and the trays and hanger do not pivot or adjust after manufacture and assembly of the cart.

Lower tray 21 preferably has a tray surface 25 and upending rim 26 around four sides of the tray 21, wherein one or more notches may be formed in the rim 26 to allow extension of one or more tools a distance out from the tray. Preferably, a portion of an elongated tool, such as a handle end, extends out from the notch to overhang in space for easy access by the user. For example, notch 28 is formed in the front portion of the rim near the left side of the tray 21 to allow an elongated farrier's file/rasp to extend from the tray, beyond the outer perimeter of the tray, so that that handle is exposed. The user may easily grasp the handle and list the file/rasp upwards and out of the tray without the rim 26 interfering with removal or insertion of the rasp.

The tray surface 25 of tray 21, which may also be called a “bottom wall” or “floor” of the tray 21, may comprise a gripping surface, partitions, or relief (such as ridges, walls, and/or indentations), or other non-planar or rough structure, for example, structure that is not co-planar with the main plane of the tray surface 25. In the preferred embodiments, a relief pattern 33 is provided that is generally a pattern of raised diamond structures, and a partition 25′ is provided to divide the tray in two portions. The relief pattern 33, or others that may be provided as alternatives, may help by maintaining position of tools or other items that are placed in the tray, so they do not tend to slide across the tray surface 25. Also, such a relief pattern 33, or others that may be provided as alternatives, may help the user grasp tools from the tray, because the user's fingers may more easily reach under at least a portion of the tool that is, in effect, raised above the main plane of the tray surface 25 by the relief pattern 33.

The middle tray 22 also has a main tray surface 34 surrounded entirely or substantially by an upending rim 35. The main surface 34 preferably also has a gripping surface, partitions, or relief (such as ridges, walls, and/or indentations), or other non-planar or rough structure, for example, structure that is not co-planar with the main plane of the tray surface to help keep tools or other items in place in the desired portion of the tray. The middle tray 22 is preferably smaller than the lower tray 21 and the middle tray 22 comprises “ears” 36, 36′ that extend out to the sides from the main, generally rectangular portion of the tray (also called the “main body”). These ears 36, 36′ each form a rectangular extension of the tray, preferably from the front of the tray side walls, for receiving an item and helping to keep it retained in that space. For example, a 250 count box of horseshoe nails will fit in said ear space and be retained there by the front 41 and rear 42 rim (sidewall) portions of the ear. In one or both ears 36, 36′, a hole 44 through the tray surface may be provided for receiving a hoof-knife or other frequently-used tool, for example.

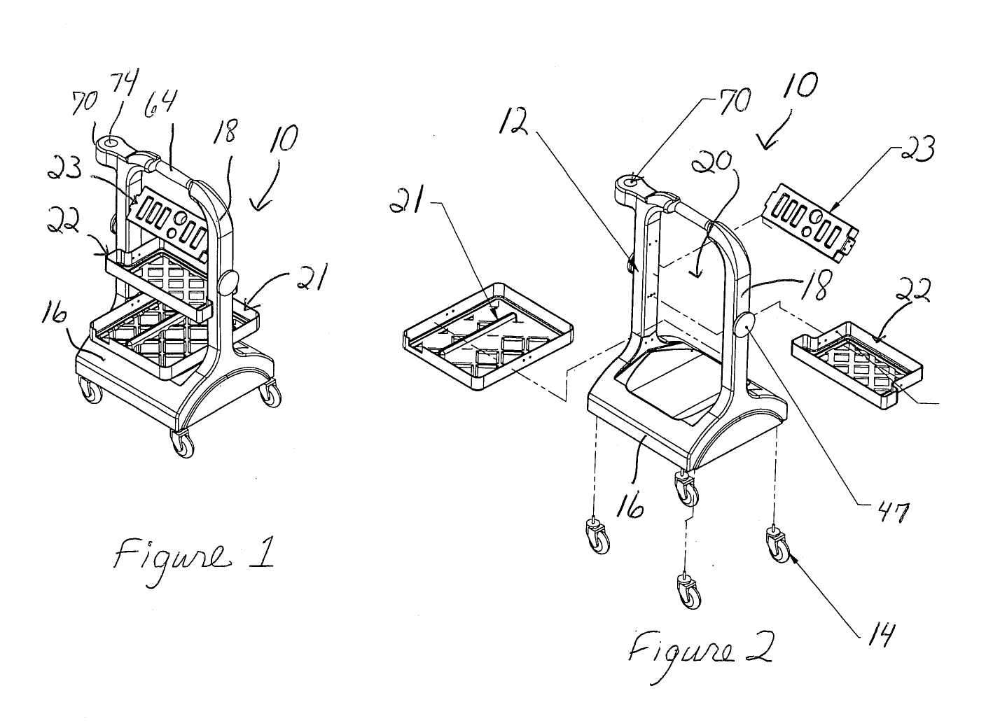

Various items may be clipped onto, or hung from, the rim 26, 35 of any of the trays. Further, one or more magnets may be provided on the front rim of any of the trays, for holding multiple nails, or other items, in a position easily reached by the user with one hand. One or more magnets 47 may be provided elsewhere on the cart 10, for example, on a side of the frame 12 (see FIG. 2).

The upper hanger 23 may be adapted to hold tools or items, by said tool/item extending through apertures in the hanger 23. For example, the upper hanger 23 of this embodiment is a generally rectangular block or shell 48 with several apertures through it in a direction transverse to its longitudinal axis and with a thickness substantial enough to help retain the tools received in said apertures in a generally straight and predictable orientation. The upper hanger may have an upper surface and a bottom surface, with the apertures 51-57 extending through the hanger 23 from upper surface to bottom surface, or, as is the case in the embodiment of FIGS. 1-6, the hanger may be a substantially hollow shell with aperture sleeves 27 giving depth to the apertures 51-57, wherein each sleeve 27 and aperture 51-57 being preferably at least 2 inches deep and more preferably 2-4 inches deep. The hanger 23 is installed/formed so that it is tilted forward so that the upper surface 24 is positioned about 40-60 degrees from horizontal (angle A), and so that the apertures (and the handles therein) are at about 50-30 degrees from horizontal (the depth dimension of the apertures being preferably perpendicular to the upper surface 24). This way, the user removes the tools from the apertures 51-57 by pulling them in a direction toward the user, with a substantial forward component (that is, pulling them mainly forward and slightly upward). Thus, while surface 24 is called “upper” in this description, it may be understood that surface 24 may indeed be substantially facing forward rather than substantially upward.

In the embodiment shown in FIGS. 1-6, three rectangular apertures 51, 52, 53 at the left end of the hanger 23 are well-adapted to receive farrier's nippers, and the two cylindrical apertures 54, 55 near the center of the hanger 23 are well-adapted to receive farrier's nail hammers. A total of seven apertures 51-57 are shown in the upper hanger 23 of this embodiment, but this may be changed for various embodiments to suit a particular use. This hanger 23 and its apertures 51-57 are particularly useful for longer tools, wherein the handle(s) is/are received in the hanger aperture and wherein the head of the tool may be grasped and the tool pulled out without significant danger to the user grasping the head. The apertures 51-57 are preferably large enough to receive both of the handles of a tool that has two handles, for example, nippers or pliers. This way, each tool's handles are held together or at least near each other and the head will be tend to be closed (sharp or pointed portions together, shielded, or otherwise preferably not protruding or exposed), and this contributes to safe handling of the tool and comfortable and easy grasping of the tool. If, on the other hand, such a tool were stored/held with only one handle extending through the hole or otherwise held by the cart, the tool orientation would be clumsy and the tool would be more likely to drop and/or would more likely cut or pinch the user when the user reaches for it.

The frame 12 is designed so that the trays 21, 22, and hanger 23 are held up off the ground/floor, but the cart is stable and unlikely to tip over. The wheels 14 are preferably spaced apart to the outer perimeter of the base portion 16, to maximize the stability of the cart. The top central portion of the frame is preferably shaped to be a handle 64, which may be grasped for pulling or pushing the cart, again with little chance of the cart tipping over. The preferred cart of FIG. 1-6 may be pushed or pulled comfortably while the user is standing straight and not bending over. This makes moving the cart from room to room or stall to stall, and maneuvering the cart into desired positions, comfortable and typically able to be accomplished with one hand.

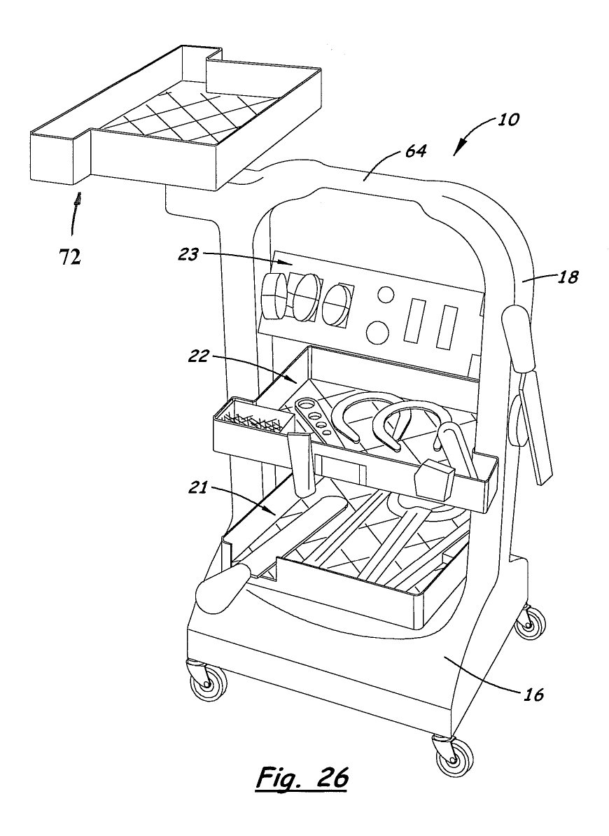

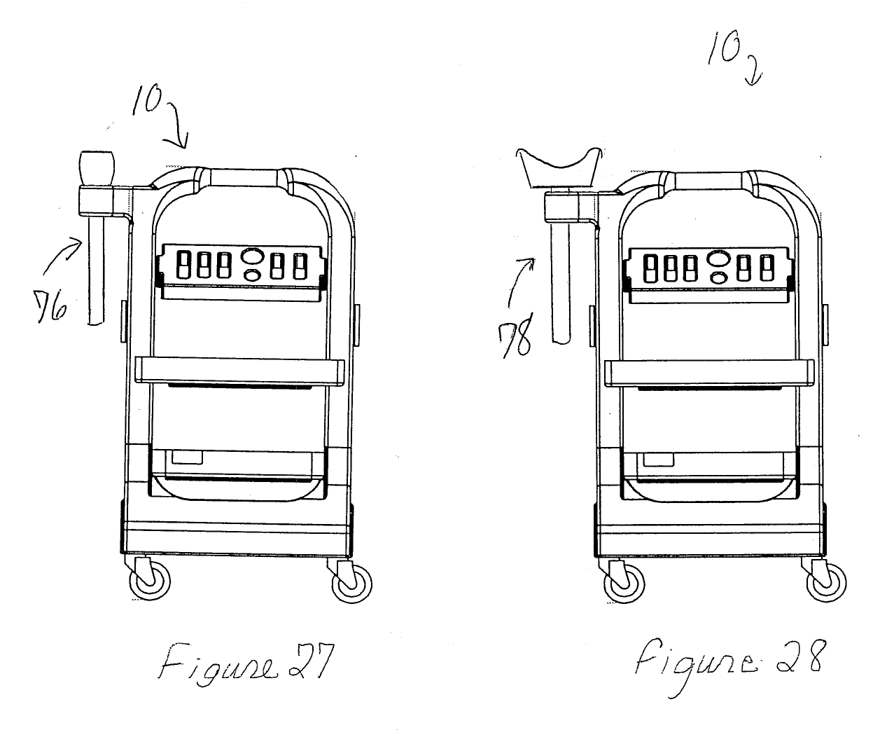

Extending from one upper corner of the frame 12 is an arm 70 which may hold a removable tray or other object. A downwardly-protruding bottom stem/post of a removable tray (also called “side-tray) 72 may be slidably received in the hole 74 through the arm 70, so that the removable tray 72 is held substantially horizontally above and to one side of the cart (see FIG. 26). In FIG. 26, the tray 72 is shown installed on the arm, and it will be understood that a short stem/post downwardly-extending from about the center of the bottom surface of the tray 72 is slidably received in the hole 74 but does not protrude any substantial length below the hole 74. This provides an extra carrying/storage surface for various tools, horseshoes, or other objects. This tray 72 may be of various shapes, for example, generally rectangular with “ears” such as described above for retaining objects at the corners of the tray. The tray extends slightly over to the side beyond the wheel base, but preferably only a few inches. This way, the tray does not substantially increase the chance that the cart will tip over. Alternatively, hole 74 may be used, without tray 72, to receive a hammer, or other tool or item, such as a post 76 or platform 78 of the inventor's hoof care stands (for example, the inventor's HoofJack® stands; see, for example, U.S. Pat. Nos. 6,325,154; 6,640,905; D491,699; 6,848,512; and D509,327). See FIGS. 27 and 28.

FIGS. 20-25 illustrate an alternative embodiment of the invented cart, which is a smaller, shorter cart 200. Much like the cart discussed above, cart 200 has a frame 212 on wheels 214, a lower tray 221, and an upper hanger 223. However, in the cart 200 of FIGS. 20-25, there is no middle tray. The lower tray 221 may have partitions, relief patterns, and also one or more notches through the upending rim (or “tray side wall”), as discussed above for cart 10. The upper hanger 223 preferably comprises the sleeves and apertures that are discussed above for hanger 23, and, likewise, hanger 223 is preferably installed so that its upper surface is at an angle to horizontal, for example, 40-60 degrees for easy access to tools that extend through the sleeves/apertures. An arm 270 extends off of the top end of the frame 212, with a hole 274 provided in the arm 270 to receive animal care objects, such as the such as the post 76 or platform 78 of a hoof care stand or other items. Optionally, an upwarding-extending handle (not shown) may be inserted through the hole 274 and removably locked in place to serve as grasp point high up above the short cart 200, to allow the user to move the cart by using said handle without bending over. This would provide the benefits of having a compact, smaller cart with the option for not having to bend over while moving the cart.

Also extending from the arm 270 is a box 272, which comprises a bottom wall and an upending generally rectangular sidewall, wherein the box 272 is deep enough (the sidewall tall enough) to securely receive objects in a way that tends to prevent them from falling or spilling over. For example, box 272 may be a good receptacle for a box of nails or other small objects (or the loose nails, screws or other objects without a container) that the user needs to reach, grasp, and remove one by one (or a few at a time) from the cart preferably without a high chance of the remaining objects falling or being brushed or flipped over the edge of the box 272.

From the above description and the figures, one may understand that the preferred cart 10, 200 and its trays, hangers with apertures, or other retainers and holding devices, are preferably designed for convenient and comfortable use, preferably even by a user that only has one hand free to reach to the cart to pick-up tools or supplies. For example, a farrier may be occupied with holding or steadying a horse leg/hoof, horseshoe, and/or other horse-care item when he/she needs to reach for another tool or item off of the cart, and he/she may do this quite easily with embodiments of the invented cart. The cart will not make noise to frighten the horse when the farrier is in a possibly precarious or dangerous position, and the farrier may often reach for the tools without having to direct his full attention to the cart, because the tools are retained or lying in their predictable locations, and are easily and comfortably removable from the trays and hanger.

The preferred embodiment is substantially or entirely made of molded polymeric materials, so that there is little or no “clanking” or metallic sound associate with use of the cart. This is particular important for work on or around horses, as they are easily frightened by metallic or loud sounds such as might come from metal tools hitting or being set in a metal cart or tray. Preferably, also, the plastic/polymer from which the cart is substantially made (preferably linear polyethylene), and the shape and contour of the cart components (for example, the radiused corners of the trays) are not likely to injure the user or a horse if either falls against, hits, kicks, or is pushed against the cart. In summary, this cart is unlikely to injure the user or horse or other animal in the vicinity of the cart, and unlikely to make any sounds that will frighten the animal or make matters worse if something else frightens the animal.

Embodiments of the invented cart may be used for purposes other than horse or animal care and to hold other items besides farrier's tools. For example, a person may use an embodiment of the cart for craft or hobby supplies. A carpenter or mechanic may use an embodiment of the cart for his/her tools. My people will find embodiments of the invented cart useful, comfortable, and safe, due to the multiplicity of storage/carrying surfaces, apertures, positions for many different tools and items, the compact size and shape of the cart, the stability of the cart, the ease of moving the cart even while it is loaded with tools/items, and the quiet and non-metallic polymer materials that preferably form all of substantially all of the cart (except perhaps the metal parts of the wheel/castors, tray or hanger fasteners, and/or magnet brackets).

The preferred cart consists of a frame on wheels/castors, and multiple, open trays and/or hangers. The preferred cart does not have sliding drawers, cabinets with doors, and/or other closed or substantially-closed storage. Preferably, all of the holding/retaining surface and space is visible to and reachable by the user.

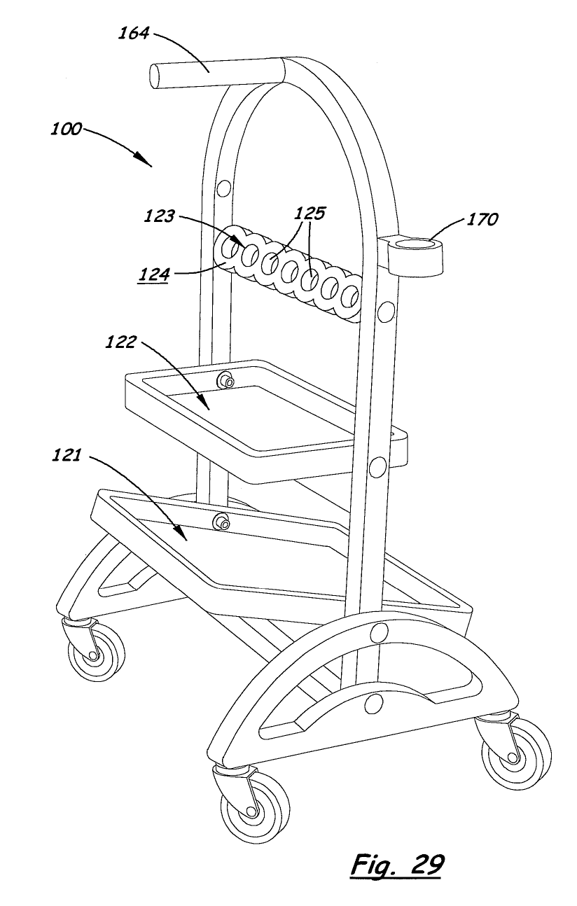

Many of the same objectives are met by the alternative embodiment of the invented cart shown in FIG. 29. This cart 100 has a lower tray 121 and a middle tray 122, wherein both are generally rectangular and have bottom surfaces and rims surrounding each tray. The lower tray 121 is formed/installed to be slightly at a tilt (preferably 10-30 degrees from horizontal). The middle tray 122 is smaller than the lower tray 121, which helps keep the tools/items on the lower tray 121 visible and easily accessible to the user. The upper hanger 123 is an elongated unit, generally in the shape of connected cylinders, wherein each cylinder has an aperture 125 for receiving a tool or item. This hanger 123 is preferably tilted so that the upper surface 124 of this hanger 123 is preferably at about 20-45 from horizontal. Arm 170 is provided on an upper portion of the frame, for receiving removable trays, tools, or other items, and elongated arm 164 extending from the top, center of the frame serves as a handle.

Although this invention has been described above with reference to particular means, materials and embodiments, it is to be understood that the invention is not limited to these disclosed particulars, but extends instead to all equivalents within the broad scope of the following claims.

1. A tool cart comprising:
a frame;
a tray secured to the frame and comprising a bottom wall for receiving a tool, an upending rim wall, and a notch through a front portion of the rim wall for receiving a handle of said tool;
a hanger secured to the frame and comprising a plurality of sleeves extending perpendicular to the upper surface of the hanger and having a depth dimension perpendicular to said upper surface, wherein each sleeve surrounds and defines an aperture and each of said sleeves and apertures is at least 2 inches deep so that tools received in said apertures are held with long dimensions of said tools parallel to said depth dimension.

2. A tool cart as in claim 1, wherein the frame comprises wheels and an interior space in which said tray and said hanger are located.

3. A tool cart as in claim 1, wherein the hanger is secured to the frame so that said upper surface of the hanger is non-horizontal.

4. A tool cart as in claim 3, wherein upper surface is at an angle of 40-60 degrees to horizontal.

5. A tool cart as in claim 1, wherein the cart comprises an arm extending generally horizontally from the frame, the arm having an arm hole extending through the arm; and the cart further comprises a side-tray with a downwardly-extending post on a bottom side of the side-tray, wherein the downwardly-extending post is slidably received in said arm hole to hold the side-tray generally horizontally beside the frame.

6. A tool cart comprising:
a wheeled frame;
a lower tray secured to the frame and comprising a bottom wall for receiving at least one hand-tool, an upending rim wall, and at least one notch in a top edge of a front portion of the rim wall for receiving a handle of one of said plurality of tools;
an upper tray secured to the frame and comprising an upper tray bottom wall for receiving tools or supplies, said upper tray having a main portion that is generally rectangular, and at least one generally rectangular corner tray portion protruding from a sidewall of the main portion;
a hanger secured to the frame and comprising a plurality of apertures extending through the hanger perpendicular to the upper surface of the hanger and having a depth dimension perpendicular to said upper surface, wherein each apertures is defined by a sleeve wall that is at least 2 inches deep so that tools received in said apertures are held with long dimensions of said tools parallel to said depth dimension.

7. A tool cart as in claim 6, wherein said lower tray bottom wall is positioned 0-20 degrees from horizontal.

8. A tool cart as in claim 6, wherein said upper tray bottom wall is positioned 0-20 degrees from horizontal.

9. A tool cart as in claim 6, wherein the hanger is secured to the frame so that the upper surface of the hanger is positioned at an angle of 40-60 degrees from horizontal.

10. A tool cart as in claim 6, wherein the hanger is secured to the frame so that the apertures extend through the hanger at an angle of 50-30 degrees from horizontal.

11. A farrier's tool cart system comprising:
a plurality of hand-tools and a box of nails;
a wheeled frame;
a lower tray secured to the frame and comprising a bottom wall for receiving at least one of said plurality of hand-tools, an upending rim wall around a perimeter of the bottom wall, and at least one notch in a top edge of a front portion of the rim wall for receiving a handle of said at least one hand-tool so that the handle extends out beyond the rim wall of the lower tray;
an upper tray secured to the frame and comprising an upper tray bottom wall for receiving tools or supplies and a upper tray upending rim wall, said upper tray having a main portion that is generally rectangular, and at least one generally rectangular corner tray portion protruding from a sidewall of the main portion, said corner tray portion having a front wall and an upending rear wall spaced apart to generally correspond to a width of said box of nails so that the corner tray portion snugly receives said box on at least two sides;
a hanger secured to the frame and comprising a plurality of apertures extending through the hanger perpendicular to the upper surface of the hanger and having a depth dimension perpendicular to said upper surface, wherein each aperture is defined by a sleeve wall, wherein multiple of said apertures receive cutting or nipping hand-tools, said cutting or nipping hand-tools having head portions that open and close for cutting or nipping by operation of handles having long dimensions, wherein the handle of said cutting or nipping hand-tools extend through said multiple apertures parallel to said depth dimension.

12. A tool cart system as in claim 11, wherein the cutting or nipping hand tools received in said multiple apertures of the hanger each comprise two handles that pivot relative to each other, and wherein both of said two handles are received in a single one of said apertures.

13. A tool cart as in claim 11, wherein said lower tray bottom wall is positioned 0-20 degrees from horizontal.

14. A tool cart as in claim 11, wherein said upper tray bottom wall is positioned 0-20 degrees from horizontal.

15. A tool cart as in claim 11, wherein the hanger is secured to the frame so that the upper surface of the hanger is positioned at an angle of 40-60 degrees from horizontal.

16. A tool cart as in claim 11, wherein the hanger is secured to the frame so that the apertures extend through the hanger at an angle of 50-30 degrees from horizontal.

17. A tool cart as in claim 11, wherein the cart comprises an interior spaced in which said lower tray, said upper try, and said hanger are secured, and the cart further comprises an arm extending generally horizontally from the frame, the arm having an arm hole extending through the arm; and the cart further comprises a side-tray with a downwardly-extending post on a bottom side of the side-tray, wherein the downwardly-extending post is slidably received in said arm hole to hold the side-tray generally horizontally beside the frame and outside of said interior space of the frame.
